(19) United States
(12) Patent Application Publication
(10) Pub. No.: US 2014/0268664 A1
(43) Pub. Date: Sep. 18, 2014

(54) CONIC DECORATIVE LAMP

(71) Applicant: CHIN-SHENG YANG, Tainan City (TW)

(72) Inventor: CHIN-SHENG YANG, Tainan City (TW)

(21) Appl. No.: 13/798,172

(22) Filed: Mar. 13, 2013

(51) Int. Cl. F21S 10/00

(52) U.S. Cl. CPC F21S 10/002
USPC 362/101

(57) ABSTRACT

A conic decorative lamp is disclosed, including: a shell, a magnet-driven element, a conic buoy and a bottom base. The magnetic-driven element and the conic buoy are disposed inside the shell. The bottom of the conic buoy is disposed with a plurality of rotational plates, disposed with interval. The bottom base is fixedly engaged to the conic shell with at least a light-emitting element disposed inside as well as a magnetic rotational axis for correspondingly attaching to the magnet-driven element, and driven by a driving element to rotate. When the magnetic rotational axis rotates, the magnet-driven element also rotates because of attachment to the magnetic rotational axis so as to wave the fluid inside the shell, which leading to pushing to rotational plats to rotate the conic buoy.

### A) FIELD OF THE INVENTION

The present invention generally relates to a conic decorative lamp, and more specifically to an aquatic lamp in a faux Christmas tree shape, by flowing the fluid to twirl the float an buoy object to display visual effect, applicable to display in an ambient space.

### B) BACKGROUND OF THE INVENTION

Decorative objects are widely used in daily life or to mark festive days, such as, photo frames, decorative toys, and so on. Most of the decorative objects can only be displayed statically. An aquatic lamp, on the other hand, can provide motions to display a variety of visual effects, for example, by manually shaking or using electricity to drive the glittering particles, pieces or decorative bits disposed inside the aquatic lamp to achieve a dynamic visual effect. Because different visual effects can be explored by disposing different elements inside the aquatic lamp, the development of aquatic lamp has become a specialty for ambient decorative manufacturers.

Therefore, it is desirable to devise an aquatic lamp able to dynamically display visual effects in addition to decorative capability so as to enhance the esthetics of the household.

### SUMMARY OF THE INVENTION

The primary object of the present invention is to provide a conic decorative lamp, including: a shell, being a three-dimensional object formed by a light-transmittable hollow cone and a light-transmittable bottom cover, sealing a fluid with slightly high viscosity; a magnet-driven element, disposed inside the shell, having a spherical bottom and radiating flip plates at the top; a conic buoy, light-transmittable and having a downward opening, having a plurality of rotational plates disposed with intervals around the edge of the opening, carried by and floating in the fluid; and a bottom base, having an upward opening fixedly engaged to the shell, being disposed with at least a light-emitting element corresponding to the bottom of the shell, inside being disposed with a magnetic rotational axis correspondingly attached to the magnet-driven element, the magnetic rotational axis being driven to rotate by a driving element; wherein when the magnetic rotational axis being in rotation, the magnet-driven element also rotating because of attachment to the magnetic rotational axis so as to wave the fluid inside the shell, which leading to pushing to rotational plats to rotate the conic buoy.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view according to the invention;

FIG. 2 shows a dissected view according to the invention;

FIG. 3 shows a cross-sectional view according to the invention;

FIG. 4 shows a schematic planar view of operation according to the invention; and

FIG. 5 shows a partial cross-sectional view according to the present invention.

### DETAILED DESCRIPTION OF THE PREFERRED EMBODIMENTS

The foregoing and other objects, features, aspects and advantages of the present invention will become better understood from a careful reading of a detailed description provided herein below with appropriate reference to the accompanying drawings.

Refer to FIGS. 1-3, which are schematic view, dissected view and cross-sectional view of the present invention, respectively. The conic decorative lamp mainly includes a shell 1, a magnet-driven element 2, a conic buoy 3 and a bottom base 4. The shell 1 is fixedly engaged to the top of the bottom base 4, with the magnet-driven element 2 and conic buoy 3 being disposed inside the shell 1.

The shell 1 is a three-dimensional object formed by a light-transmittable conic hollow main body 11 and a light-transmittable bottom cover 12. The main body 11 is disposed with a tree-top star-shape decoration 13 at the top and the bottom cover 12 is a hollow cylinder so that the shell 1 has a shape similar to a Christmas tree; wherein the tree-stop star-shape decoration 13 can be an extension part from the main body 11; and the shell seals in a fluid with slightly high viscosity, doped with glittering particles or pieces.

The magnet-driven element 2 has spherical bottom and a flat top disposed with radiating flip plates 21. The magnet-driven element 2 is disposed inside the main body 11.

The conic buoy 3 is disposed inside the shell 1, is light-transmittable and has a downward opening 31. The opening 31 has a plurality of rotational plates 32 disposed with intervals around the edge of the opening 31. The conic buoy 3 is carried by and floating in the fluid inside the shell 1. In the present embodiment, the conic buoy 3 is made of transparent material.

The bottom base has an upward opening 41 fixedly engaged to the shell 1. A light-emitting element 42 is disposed inside the bottom base to correspond to the bottom cover 12 of the shell 1 for projecting light onto the light-transmittable shell 1 to enhance the visual esthetics. A magnetic rotational axis 43 is disposed inside the bottom base 4 correspondingly attached to the magnet-driven element 2. The magnetic force of the magnetic rotational axis 43 is from a magnet, preferably a powerful magnet. The magnetic rotational axis 43 is driven by a driving element 44 to rotate. Also, the bottom cover 12 is disposed with a protruding ring 14, for restricting the magnet-driven element 2 to rotate within the range of the protruding ring 14.

Refer to FIG. 4 and FIG. 5. Because of the attachment of the magnetic rotational axis 43, the magnet-driven element 2 sinks at the bottom of the shell 1, and the conic buoy 3 is carried by the force of the fluid inside the shell 1 to stay floating, and using the conic tip to fit the inside of the conic shell 1 so as to limit the rational range of the conic buoy 3 inside the shell 1.

In addition, the driving power for the light-emitting element 42 and the driving element 44 is controlled by a switch 45, and the power source can be corresponding battery or by other means of AC or DC.

The magnetic rotational axis being driven to rotate by a driving element; wherein when the magnetic rotational axis being in rotation, the magnet-driven element also rotating because of attachment to the magnetic rotational axis so as to wave the fluid inside the shell, which leading to pushing to rotational plats to rotate the conic buoy. The power source can be of other types, and is not within the scope of the present invention.

In the embodiment, the light-emitting element 42 can be designed as a light-emitting diode (LED), which can provide a variety of light colors to further enhance the visual effect of the present invention.

As such, when the magnetic rotational axis 43 rotates, the magnet-driven element 2 also rotates due to the attachment to the magnetic rotational axis 43 so as to wave the fluid inside the shell 1. The fluid, in turn, pushes the rotational plates 32 at the bottom of the conic buoy 3 so that the conic buoy 3 also rotates by the dragging of the fluid to display dynamic visual effects.

The specific operation of the present invention can be described as follows. An electrical power drives the light-emitting element 42 to laminate and the driving element 44 to operate, and then the magnetic rotational axis 43 rotates due to the driving of the driving element 43. The magnet-driven element 2 also rotates due to the attachment to the magnetic rotational axis 43 and uses the flip plates to wave the fluid inside the shell 1 to flow in the same direction and to disturb the glittering particles or pieces doped in the fluid to flow along. The flowing fluid pushes the rotational plates 32 disposed on the conic buoy 3 to rotate the conic buoy 3 so that the present invention can show a visual effect of a rotational Christmas tree to further enhance the effect.

In summary, the present invention shows features of progression and industrial utilization and the structure and the features of the present invention has never been publicly disclosed, thus, shows feature of novelty. Therefore, the present invention meets the requirements of patent application.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A conic decorative lamp, comprising:
a shell, being a three-dimensional object formed by a light-transmittable hollow cone and a light-transmittable bottom cover, sealing a fluid with slightly high viscosity;
a magnet-driven element, disposed inside the shell, having a spherical bottom and radiating flip plates at the top;
a conic buoy, light-transmittable and having a downward opening, having a plurality of rotational plates disposed with intervals around the edge of the opening, carried by and floating in the fluid; and
a bottom base, having an upward opening fixedly engaged to the shell, being disposed with at least a light-emitting element corresponding to the bottom of the shell, inside being disposed with a magnetic rotational axis correspondingly attached to the magnet-driven element, the magnetic rotational axis being driven to rotate by a driving element;
wherein when the magnetic rotational axis being in rotation, the magnet-driven element also rotating because of attachment to the magnetic rotational axis so as to wave the fluid inside the shell, which leading to pushing to rotational plats to rotate the conic buoy.

2. The conic decorative lamp as claimed in claim 1, wherein the shell is disposed with a star-shape decoration at the tip.

3. The conic decorative lamp as claimed in claim 2, wherein the star-shape decoration is an extension part of the shell.
